(19) United States
(12) Patent Application Publication
(10) Pub. No.: US 2007/0024778 A1
(43) Pub. Date: Feb. 1, 2007

(54) Semi-transmissive liquid crystal display device

(75) Inventors: Masayuki Kametani, Tottori-shi (JP); Hirofumi Ohira, Tottori-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO EPSON IMAGING DEVICES CORP., Tokyo (JP)

(21) Appl. No.: 11/492,088

(22) Filed: Jul. 25, 2006

(30) Foreign Application Priority Data
Jul. 28, 2005 (JP) 2005-218545

(51) Int. Cl. G02F 1/1335

(52) U.S. Cl. 349/114

(57) ABSTRACT

Provided is a semi-transmissive liquid crystal display device having a pair of substrates 11, 21, which employs ECB mode liquid crystals in which a protruding portion 23 used for adjusting a cell gap provided on a reflective portion 15 of each pixel in one of the substrates extends in a first direction, wherein a liquid crystal injection inlet “a” is provided at a position such that an angle θ between a tangent “c” of a circular arc “b” drawn with the liquid crystal injection inlet “a” as its center and the orienting direction of an alignment layer on the side comprising the protruding portion 23, is never at a right angle when the orienting direction of the alignment layer formed on one of the substrates intersects with the protruding portion 23, or is provided at a position such that a contact point of the tangent “c” where the circular arc “b” tangent “c” and the orienting direction of the alignment layer on the side comprising the protruding portion 23 are at a right angle is on an edge of the glass substrate. In such case, the semi-transmissive liquid crystal display device may have a topcoat wherein the protruding part 23 is provided on a reflective portion of a color filter substrate, and may also have an interlayer film wherein the protruding part 23 is provided on a reflective portion of a matrix substrate side. These features allow a semi-transmissive liquid crystal display device to be provided which employs ECB mode liquid crystals having little unevenness in the orientation of the liquid crystals.

### BACKGROUND OF THE INVENTION

The present invention relates to a semi-transmissive liquid crystal display device, and in particular relates to a semi-transmissive liquid crystal display device which employs ECB mode liquid crystals and which has little occurrence of orientation unevenness of the liquid crystals.

In recent years the application of liquid crystal display devices has rapidly spread into not only information-communication devices, but general electrical equipment as well. Since liquid crystal display devices do not themselves emit light, transmissive-type liquid crystal display devices provided with a backlight are commonly employed. However, because the backlight consumes a large amount of power, particularly for portable devices, reflective-type liquid crystal display devices which do not require a backlight are being used to reduce power consumption. Nonetheless, since reflective liquid crystal display devices utilize external light as a light source, it is difficult to view these devices in a dark room or similar environment. In view of this, in recent years development has especially been progressing into semi-transmissive-type liquid crystal display devices which combine transmissive-type and reflective-type qualities (refer to Japanese Patent Laid-Open No. 11-101992 and Japanese Patent Laid-Open No. 2005-106997).

Such a semi-transmissive liquid crystal display device comprises, in a single pixel region, a transmissive portion comprising a pixel electrode, and a reflective portion comprising both a pixel electrode and a reflective electrode. In dark places, the backlight is lit up and the pixel region transmissive portion is utilized to display an image, while in bright places, external light is utilized at the reflective portion to display an image without the backlight being lit up. This means that the backlight does not have to be lit at all times, which has the advantage that power consumption can be dramatically reduced.

One example of such a semi-transmissive liquid crystal display device will be explained with reference to FIGS. 5 and 6. FIG. 5 is a plan view of one pixel displayed when viewed through the color filter substrate of a related art semi-transmissive liquid crystal display device. FIG. 6 is a cross-sectional view along the line VI-VI of FIG. 5 comprising a color filter substrate.

This semi-transmissive liquid crystal display device 10 comprises a matrix substrate and a color filter substrate. The matrix substrate is provided with a plurality of scanning lines 12 and signal lines 13 which are formed in a matrix pattern on a transparent insulating glass substrate 11. Here, the region enclosed by the scanning lines 12 and signal lines 13 corresponds to one pixel, wherein a TFT (Thin Film Transistor) (not shown) acting as a switching device is formed for each pixel.

Further, an interlayer film 17 comprising an organic insulating film is laminated so as to cover the scanning lines 12 and signal lines 13, wherein tiny uneven portions are formed on the surface at the reflective portion 15 and wherein the surface at the transmissive portion 16 is made flat. The interlayer film 17 is provided with a contact hole 20 at a location corresponding to the drain electrode of the TFT. For each pixel, a reflective electrode 18 comprising aluminum metal, for example, on its reflective portion 15 is formed on the contact hole 20 and the surface of the interlayer film 17, and an alignment layer 21 is formed via a transparent pixel electrode 19 comprising ITO (Indium Tin Oxide), for example, on the surface of this reflective electrode 18 and the surface of the interlayer film 17 of the transmissive portion 16.

Further the color filter substrate is provided with a color filter layer 22 on a surface of a transparent insulating glass substrate 21. A protruding portion 23 is provided on the surface of the color filter layer 22, comprising a transparent topcoat layer for narrowing the cell gap d1 at the reflective portion 15 to half that of the cell gap d2 of the transmissive portion 16. Therefore, the thickness of the layer provided on the surface of the color filter substrate glass substrate 21 varies greatly at the boundary between the reflective portion 15 and the transmissive portion 16. An alignment layer 25 is formed via a transparent opposing electrode 24 comprising ITO above the protruding portion 23, which comprises a reflective portion 15 topcoat layer, as well as above the color filter layer 22 of the transmissive portion 16. Further, an aperture 26 for making the color tone of the reflective portion 15 the same as that of the transmissive portion 16 is provided on a part of the color filter layer 22 of the reflective portion 15. The topcoat layer is also provided inside this aperture 26.

While an example has been illustrated here where the protruding portion 23 has a transparent topcoat layer for narrowing the cell gap d1 at the reflective portion 15 to half that of the cell gap d2 of the transmissive portion 16, is provided on the color filter layer substrate side, the protruding portion 23 may also be provided on the matrix substrate side. In that case, the thickness of the interlayer film of the reflective portion on the matrix substrate side is thicker than that of the transmissive portion interlayer film only by the protruding portion amount, and the thickness of the layer provided on the surface of the matrix substrate glass substrate 11 varies greatly at the boundary between the reflective portion 15 and the transmissive portion 16.

A semi-transmissive liquid crystal display device is fabricated by aligning the above-described matrix substrate and the color filter substrate so that they oppose each other, then laminating around the periphery with a sealant and enclosing liquid crystals into the interior. Injection of liquid crystals into a liquid crystal display device is usually conducted by dipping a liquid crystal injection inlet provided in the liquid crystal display device into a liquid crystal bath that is filled with liquid crystals. Methods for injecting the liquid crystals include an injection method which subjects an empty cell interior to vacuum suction; an injection method illustrated in Japanese Patent Laid-Open No. 11-101992, which provides a secondary injection inlet to thereby generate a pressure difference between the two injection inlets; and an injection method which utilizes capillary action based on the fact that an empty cell is a fine gap.

For example, for the liquid crystal display device 50 described in Japanese Patent Laid-Open No. 6-180457, as illustrated in FIG. 7, the matrix substrate 51 and the color filter substrate 52 oppose each other over a certain gap and are laminated around their periphery, wherein first and second substrates 51, 52 are stored in a chamber 56 used for liquid crystal injection in a state such that a liquid crystal injection inlet 53 provided on a corner of one side face of both substrates is dipped into a liquid crystal bath 54 while a secondary injection inlet 55 is not brought into contact with the liquid crystal bath 54, and the interior of the chamber 56 used for liquid crystal injection is maintained in an airtight condition and the air pressure at the liquid crystal injection inlet 53 side is made greater than that at the secondary injection inlet 55 side, whereby liquid crystals 57 are injected into an empty cell 58.

Japanese Patent Laid-Open No. 5-61054 discloses a liquid crystal display device which has a liquid crystal injection inlet provided in the center region of one side face of a substrate. Liquid crystal display devices which have an injection inlet provided in the center region of one side face of the substrate, such as the above-described, can attain the best liquid crystal injection efficiency, as such devices have the shortest leading distance for the liquid crystals into the empty cells in the liquid crystal injection step.

However, for a liquid crystal display device comprising such a structure, it is necessary to align (orient) the liquid crystal molecules of the liquid crystals enclosed in the interior in a fixed array. Thus, the above-described matrix substrate and color filter substrate are respectively formed with alignment layers 21 and 25 (refer to FIG. 5) for orienting the liquid crystal molecules. Such an alignment layer includes a given material (e.g., a polyimide), and comprises a perpendicular alignment layer which orients the liquid crystals in a perpendicular direction or a slightly slanted direction from perpendicular with respect to the substrate, and a horizontal alignment layer which orients the liquid crystals in a horizontal direction or a slightly slanted direction from horizontal with respect to the substrate, whereby the alignment layer can be selectively used depending on the kind of display mode (e.g., TN mode, STN mode, ECB mode (Electrically Controlled Birefringence) and the like). For example, in ECB mode and TN mode a horizontal alignment layer is used (as disclosed in Japanese Patent Laid-Open No. 6-301036, for instance).

The process for forming this alignment layer is generally, conducted by coating a solution, in which the alignment layer forming material has been dissolved in a solvent, onto a substrate by a certain method, heating the substrate to cause only the solvent to volatize off (pre-heating), then heating the alignment layer forming material from which the solvent has been volatized off at an even higher temperature to harden (heat) the alignment layer forming material and thereby form an alignment layer. The alignment layer is subsequently subjected to a rubbing treatment (as disclosed in Japanese Patent Laid-Open No. 5-203953 and 10-161078).

As used here, the “rubbing treatment” brings the alignment layer formed on the substrate surface into contact with a rubbing roller, around which is wound a rubbing fabric made from cloth or the like. This roller is rotated so as to rub against the surface of the alignment layer in one direction, whereby the nap on the alignment layer surface is made to stand up and form grooves, thereby conferring a certain energy directivity which controls the alignment direction of the liquid crystal molecules in the rubbing direction.

FIG. 8 is a plan view illustrating the positional relationship between a substrate to be treated and a rubbing roller in a related art rubbing treatment process. In FIG. 8, a substrate to be treated 60 provided on a stage has a structure wherein a transparent electrode is formed on a main face of a rectangular-tabular glass substrate 61 and an alignment layer 62 is formed over the glass substrate 61. The rubbing roller 63 has a structure such that rubbing fabric 65 is wound around the surface of a rotating roller 64. In the rubbing treatment in this case, the rubbing roller 63 is brought into contact at a fixed pressure with a surface of the alignment layer 62, and while rotating the rubbing roller 63 centered on rotation axis 66, at a certain speed in a certain direction 68, the substrate to be treated 60 is, for example, moved in a longitudinal direction X, whereby the rubbing treatment is carried out in a fixed direction on the surface of the alignment layer 62. At this time, the relative movement direction 69 between the rubbing roller 63 and the rotation axis direction 67 in the plane parallel to the stage mounting face is normally set at 90°, although the angle φ formed by the relative movement between the longitudinal direction X of the substrate to be treated 60 and the rubbing roller 63 changes depending on the kind of display mode.

For example, when using TN mode, it is necessary to offset the orienting direction with respect to one substrate 90° from the orienting direction with respect to the other substrate. Therefore, if the rubbing treatment is conducted with the angle φ with respect to one substrate equaling 0°, i.e. so that the relative movement direction 69 of the rubbing roller 63 is parallel to the longitudinal direction X of the substrate to be treated 60, the angle φ with respect to the other substrate must equal 90°, i.e. the rubbing treatment must be conducted so that the longitudinal direction X of the substrate to be treated 60 is at right angles (parallel to the width direction Y) to the relative movement direction 69 of the rubbing roller 63.

In contrast, two kinds of treatment exist for ECB mode; one in which the initial orientation of the liquid crystal molecules is a horizontal orientation (homogeneous alignment), and another in which the initial orientation of the liquid crystal molecules is a perpendicular orientation (homeotropic alignment). Of these, and especially for a liquid crystal display device which employs the former ECB mode, the liquid crystal display device is a “normally white” type wherein the liquid crystal molecules enclosed in between the pair of glass substrates are orientated horizontally with respect to the two substrates when voltage is not applied, so that the display can be activated by applying voltage. Thus, for this ECB mode, the rubbing direction in the rubbing treatment applied to the matrix substrate and color filter substrate pair are opposite directions rotated 180° from each other.

However, for a semi-transmissive liquid crystal display device employing ECB mode liquid crystals such as that described above, it was found that due to the differences in production conditions of the semi-transmissive liquid crystal display device, partial disarray in the orientation of the liquid crystal molecules (domain) might occur. The inventors of the present invention learned from wide-ranging investigation into the causes of domain in semi-transmissive liquid crystal display devices employing such ECB mode liquid crystals, that, essentially, as illustrated in FIG. 9, when rubbing is conducted with a rubbing roller 63 on the boundary between a reflective portion 15 and a transmissive portion 16, since there is a difference in levels as a result of, for example, the presence of a protruding portion 23 used for cell gap adjustment provided on the color filter substrate, the alignment layer 21 is not uniformly rubbed at the portion X enclosed by the broken line in FIG. 9, for instance, thereby causing the alignment control of the liquid crystal molecules at this portion to be weak. Based on this, the present inventors made the discovery that the domain occurring in this portion could essentially be eliminated by maintaining the conditions during liquid crystal injection in a specific state.

### SUMMARY OF THE INVENTION

That is, it is an object of the present invention to provide a semi-transmissive liquid crystal display device which employs ECB mode liquid crystals that has little unevenness in the orientation of the liquid crystals.

The present invention can achieve the above-described object with the following constitution. Namely, a semi-transmissive liquid crystal display device, which employs ECB mode liquid crystals according to one aspect of the present invention, comprises a pair of substrates, and provides a protruding portion extending in a first direction used for adjusting a cell gap on a reflective portion of each pixel in one of the substrates, and when an orienting direction of an alignment layer formed on said one of the substrates intersects with the protruding portion extending in said first direction, a liquid crystal injection inlet is provided at a position such that a tangent of a circular arc drawn with said liquid crystal injection inlet as a center and the orienting direction of the alignment layer on the side comprising said protruding portion are never at a right angle, or is provided at a position such that a contact point of the tangent where said tangent of a circular arc and the orienting direction of the alignment layer of said one of the substrates are at a right angle is on an edge of said substrate.

Further, the semi-transmissive liquid crystal display device, which employs ECB mode liquid crystals according to the above aspect, may comprise a topcoat wherein said protruding part is provided on a reflective portion of a color filter substrate.

Further, the semi-transmissive liquid crystal display device, which employs ECB mode liquid crystals according to the above aspect, may comprise an interlayer film wherein said protruding part is provided on a reflective portion of a matrix substrate side.

Further, when the orienting direction of the alignment layer of said one of the substrates is inclined with respect to the semi-transmissive liquid crystal display device, said semi-transmissive liquid crystal display device, which employs ECB mode liquid crystals according to the above aspect, may provide said liquid crystal injection inlet at any one of a periphery of an opposite side to the orienting direction of said alignment layer, or three corners intersecting in this periphery vicinity.

Further, when the orienting direction of the alignment layer of said one of the substrates is in a longitudinal direction of the semi-transmissive liquid crystal display device, said semi-transmissive liquid crystal display device which employs ECB mode liquid crystals according to the above aspect, may provide said liquid crystal injection inlet at any one of a periphery, or periphery both sides thereof, of an opposite side to the orienting direction of said alignment layer, or at any of the corners.

The present invention can also achieve the above-described object with the following constitution. Namely, a semi-transmissive liquid crystal display device, employs ECB mode liquid crystals according to another aspect of the present invention, comprises a pair of substrates, and provides a protruding portion extending in a first direction used for adjusting a cell gap on a reflective portion of each pixel in one of the substrates, a liquid crystal injection inlet being provided so that an orienting direction of an alignment layer formed on said one of the substrates is parallel to the protruding portion extending in said first direction.

As will now be described in more detail in the following examples, according to the above constitutions the present invention provides a semi-transmissive liquid crystal display device employing ECB mode liquid crystals which comprises a protruding portion used for adjusting a cell gap on a reflective portion, wherein a good display quality can be obtained since domain essentially no longer occurs due to the presence of the protruding portion.

### BRIEF DESCRIPTION OF THE DRAWINGS

FIG. 1 is a diagram illustrating a movement state of liquid crystals as a consequence of a disparity in positions of the liquid crystal injection inlet, wherein FIG. 1A is a diagram illustrating the case where the liquid crystal injection inlet is located in the center of any one of a periphery, and FIG. 1B is a diagram illustrating the case where the liquid crystal injection inlet is located at the edge of any one of a periphery.

FIGS. 2A to 2G are diagrams illustrating the occurrence of domain when the rubbing direction and liquid crystal inlet position were variously altered.

FIG. 3 is a diagram illustrating the relationship between rubbing direction and the angle between a tangent of a circular arc drawn with a liquid crystal injection inlet as its center for a substrate formed with a protruding portion.

FIGS. 4A to 4C are diagrams illustrating the relationship between rubbing direction and the liquid crystal injection inlet formed position in a substrate formed with a protruding portion which provides the effects according to the present invention.

FIG. 5 is a plan view of a single pixel as viewed through the color filter substrate of a related art semi-transmissive liquid crystal display device.

FIG. 6 is a cross-sectional view along VI to VI of FIG. 5 including the color filter substrate.

FIG. 7 is a diagram illustrating the process of injecting liquid crystals into a related art liquid crystal display device.

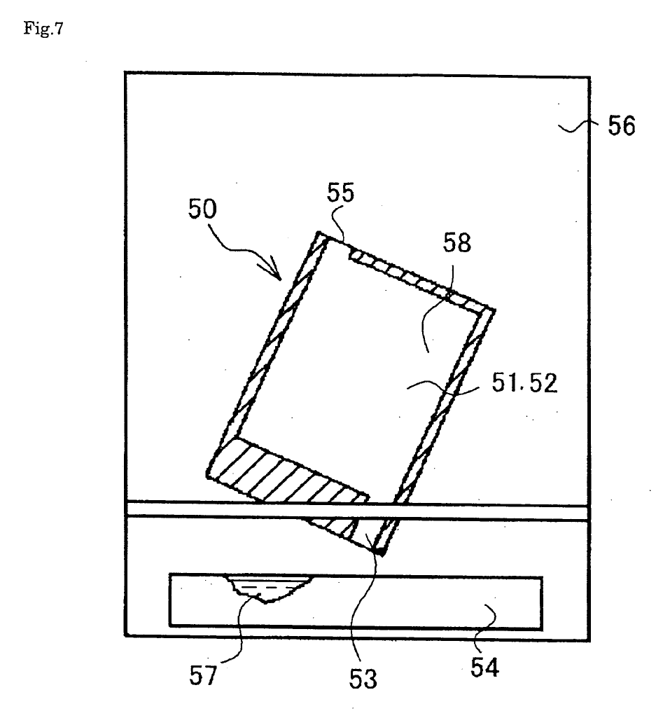

FIG. 8 is a plan view illustrating the positional relationship between a substrate to be treated and a rubbing roller during a related art rubbing treatment process.

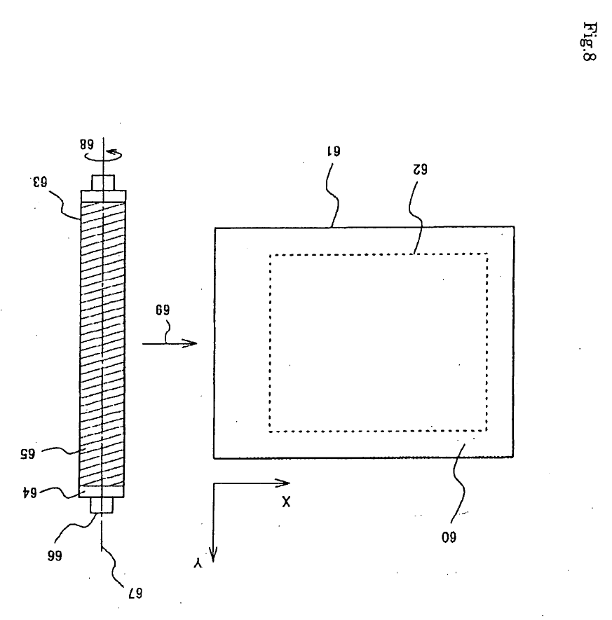

FIG. 9 is a cross-sectional view of the boundary vicinity of the transmissive portion and the reflective portion during rubbing for a related art rubbing treatment process.

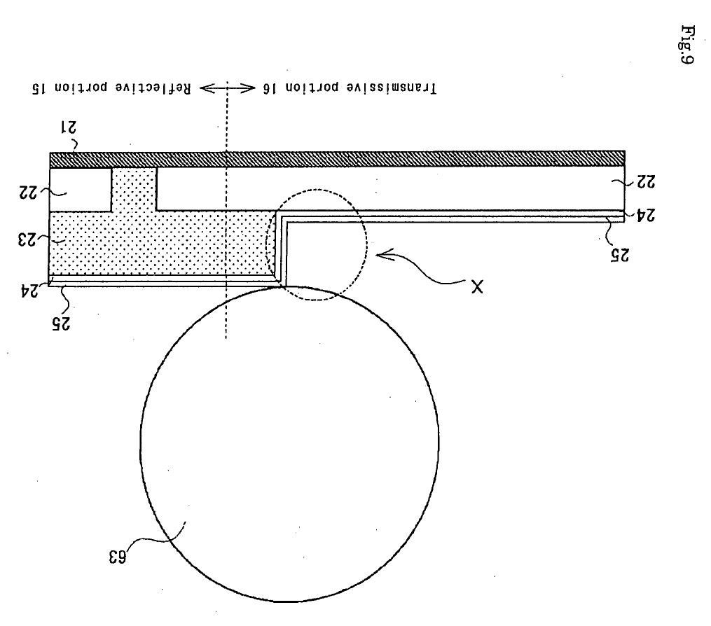

### DESCRIPTION OF THE PREFERED EMBODIMENT

The most preferred embodiment for carrying out the present invention will now be explained in detail with reference to the drawings. Although the below embodiment illustrates a semi-transmissive type liquid crystal display employing ECB mode liquid crystals in order to describe the technical ideas behind the present invention in more detail, this embodiment is in no way intended to limit the present invention. The present invention can equally be applied to other embodiments, which are contained within the scope of claims.

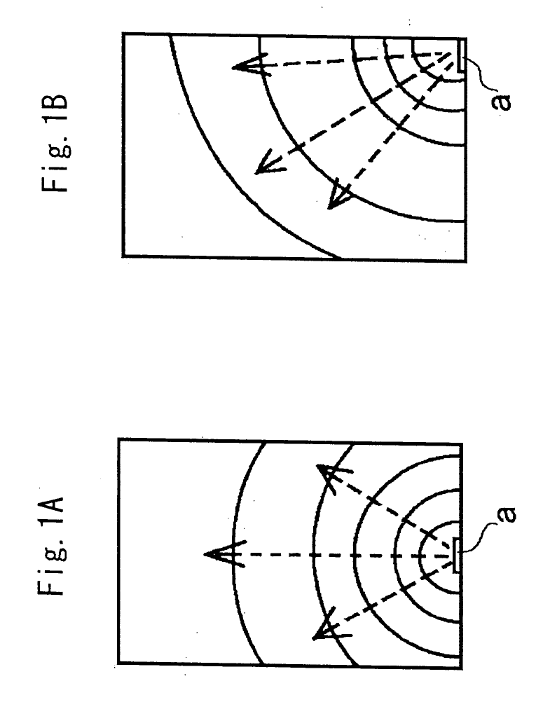

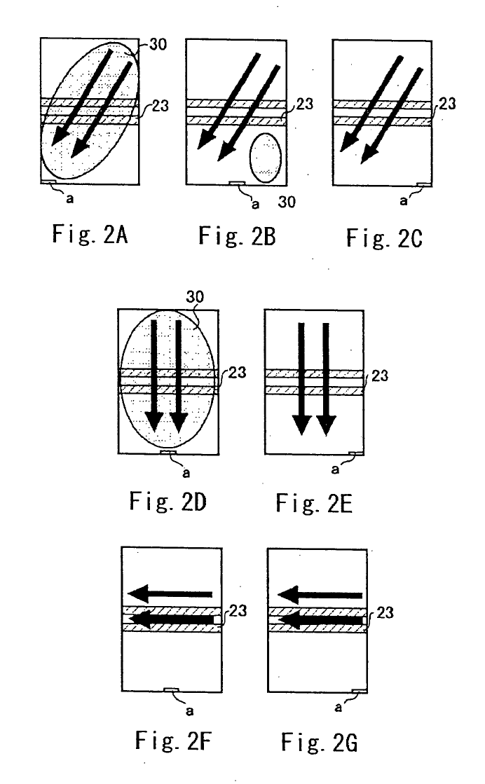

FIG. 1 is a diagram illustrating a movement state of liquid crystals as a consequence of a disparity in positions of the liquid crystal injection inlet. FIG. 1A is a diagram illustrating the case where the liquid crystal injection inlet is located in the center of any one of a periphery, and FIG. 1B is a diagram illustrating the case where the liquid crystal injection inlet is located at the edge of any one of a periphery. FIGS. 2A to 2G are diagrams illustrating the occurrence of domain when the rubbing direction and liquid crystal inlet position were variously altered.

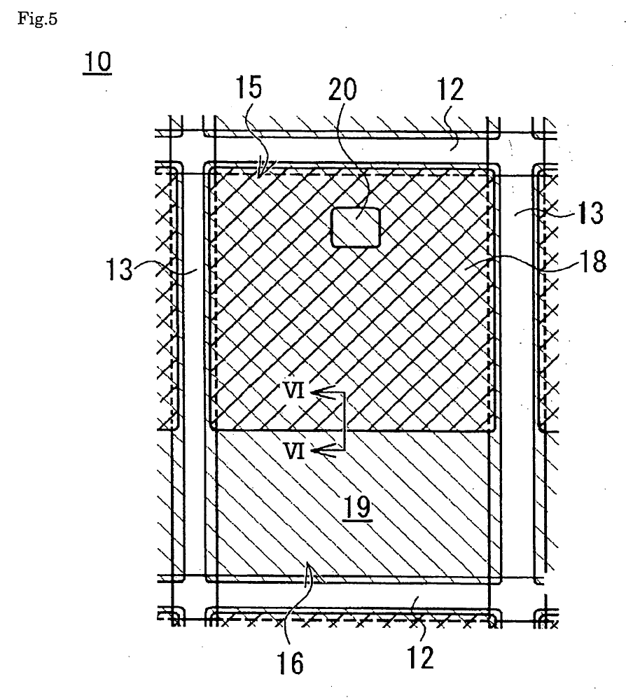

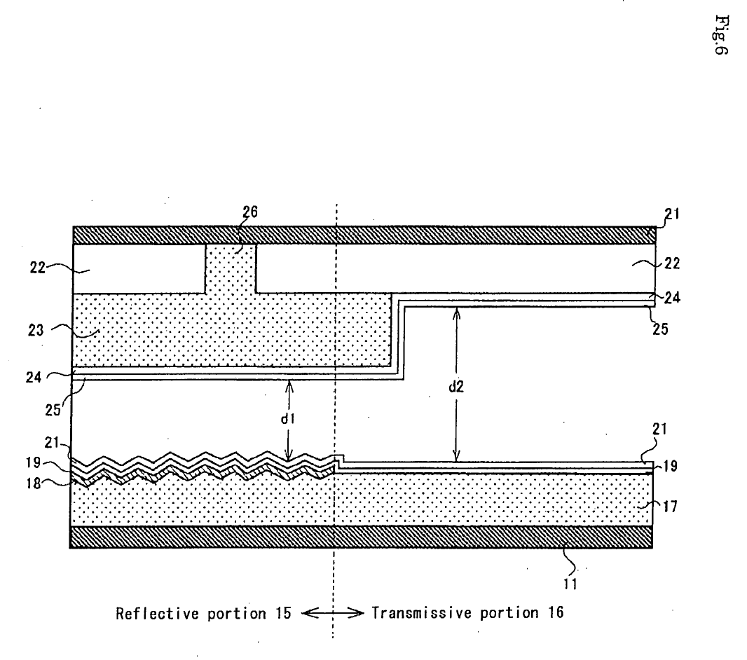

First, an active matrix substrate and a color filter substrate the same as in the related art illustrated in FIGS. 5 and 6 were fabricated. The alignment layers of the two substrates were subjected to a rubbing treatment in predetermined directions that differed 180° from each other. The peripheries of the two substrates were then covered with a sealant, and a semi-transmissive liquid crystal display device (sample A) provided with a liquid crystal injection inlet “a” in the center of any one of a periphery thereof, and a semi-transmissive liquid crystal display device (sample B) provided with a liquid crystal injection inlet at the edge of any one of a periphery thereof, were fabricated. When these samples A and B were injected with liquid crystals using the liquid crystal injection method described in Japanese Patent Laid-Open No.5-61054, the spread in the samples A and B of the liquid crystals was as shown in FIGS. 1A and 1B. The curve of the solid line in FIGS. 1A and 1B indicates the front edge position that the liquid crystals reached per given time period, and the dotted line arrow indicates the direction of progress for the liquid crystals. When the liquid crystal injection inlet “a” was provided on an edge of any one of a periphery, the liquid crystals were injected by tilting the liquid crystal display device so that the liquid crystal injection inlet “a” faced downwards. However, in FIG. 1, in order to make the comparison easier, samples A and B are shown lined up in the same direction (this is the same for the other drawings).

Next, semi-transmissive liquid crystal display devices were fabricated that employed ECB mode liquid crystals in which the orienting direction of the alignment layer for the substrate on which the protruding portion was formed, and the position of the liquid crystal injection inlet, were variously altered, whereby domain occurrence was investigated. The results are shown in FIG. 2. FIGS. 2A to 2C illustrate cases where the orienting direction of the alignment layer for the substrate on which the protruding portion was formed was inclined with respect to the liquid crystal display device, and only the position of the liquid crystal injection inlet was altered. FIGS. 2D and 2E illustrate cases where the orienting direction of the alignment layer was set in a longitudinal direction of the liquid crystal display device (position where the liquid crystal injection inlet “a” is located was set in a downwards direction; hereinafter the same), and the position of the liquid crystal injection inlet was altered. FIGS. 2F and 2G illustrate cases where the orienting direction of the alignment layer was parallel to the protruding portion 23 and in a transverse direction to the liquid crystal display device, and the position of the liquid crystal injection inlet was altered. In FIGS. 2A to 2G, the protruding portion 23 is schematically shown with hatching, the orienting direction of the alignment layer is indicated with a bold arrow, and domain occurrence locations 30 are enclosed by ellipses.

The following can be understood by referring to FIGS. 2A to 2C, in which the orienting direction of the alignment layer on the substrate on which the protruding portion is formed was inclined with respect to the liquid crystal display device. That is, in FIG. 2A the liquid crystal injection inlet “a” was provided in a left corner, and the liquid crystals injected from the liquid crystal injection inlet “a” spread out parallel to and in an opposite direction from the orienting direction of the alignment layer, whereby domain 30 essentially occurred over the entire area, and thus the resulting product was defective. In FIG. 2B the liquid crystal injection inlet “a” was provided in a center portion, wherein at the center portion and left side thereto, where the liquid crystals injected from the liquid crystal injection inlet “a” spread out in a direction which intersected with the orienting direction of the alignment layer, domain did not occur. Domain 30 only occurred at the lower right side, where the liquid crystals spread out in a direction opposite to the orienting direction of the alignment layer. Further, in FIG. 2C the liquid crystal injection inlet “a” was provided in a right corner, and the liquid crystals injected from the liquid crystal injection inlet “a” spread out in a direction, which intersected with the orienting direction of the alignment layer. Domain essentially did not occur.

Similarly, the following can be understood by referring to FIGS. 2D and 2E, in which the orienting direction of the alignment layer was set in a longitudinal direction of the liquid crystal display device. That is, in FIG. 2D, wherein the liquid crystal injection inlet “a” was provided in a center portion, the liquid crystals injected from the liquid crystal injection inlet “a” spread out in a direction which was parallel to and in an opposite direction from the orienting direction of the alignment layer, domain 30 essentially occurred over the entire area, and thus the resulting product was defective. Further, in FIG. 2E, wherein the liquid crystal injection inlet “a” was provided in a corner, the liquid crystals injected from the liquid crystal injection inlet “a” spread out in a direction which intersected with the orienting direction of the alignment layer, and domain essentially did not occur.

Similarly, in FIGS. 2F and 2G, wherein the orienting direction of the alignment layer was parallel to the protruding portion 23 and in a transverse direction to the liquid crystal display device, and the position of the liquid crystal injection inlet “a” was altered, essentially no domain occurred even when the liquid crystal injection inlet “a” was provided in a center portion (FIG. 2F), or even when provided in a corner (FIG. 2G).

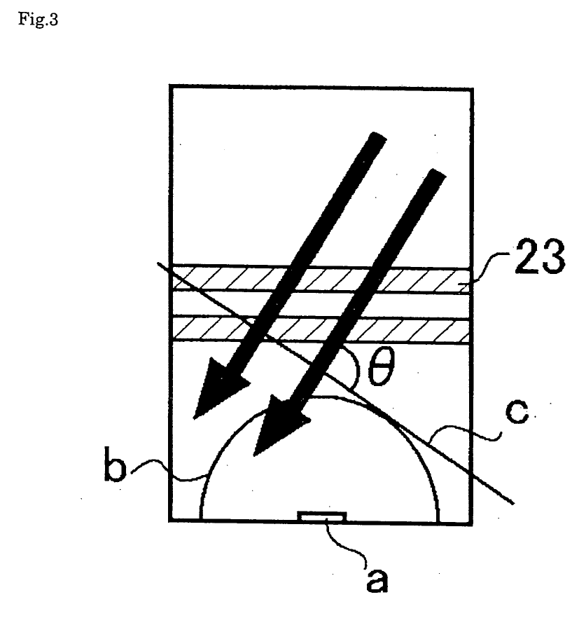

Thus, taking all of what is illustrated in FIGS. 2A to 2G into consideration, as shown by FIGS. 2A to 2E, it can be understood that when the orienting direction of the alignment layer intersects with the protruding portion, the angle between the rubbing direction on the substrate formed with either a protruding portion of the topcoat provided on a reflective portion of a color filter substrate or a protruding portion of an interlayer film provided on a reflective portion of a matrix substrate side, and the traveling direction of the liquid crystals injected from the liquid crystal injection inlet “a” (i.e. the angle θ (see FIG. 3) between the rubbing direction on the substrate formed with a protruding portion and the tangent “c” of the circular arc “b” drawn with the liquid crystal injection inlet “a” as its center) is a right angle at some points. It is also understood that unless the contact point between the tangent “c” and the circular arc “b” is in the vicinity of the substrate edge, domain is more susceptible to occurring.

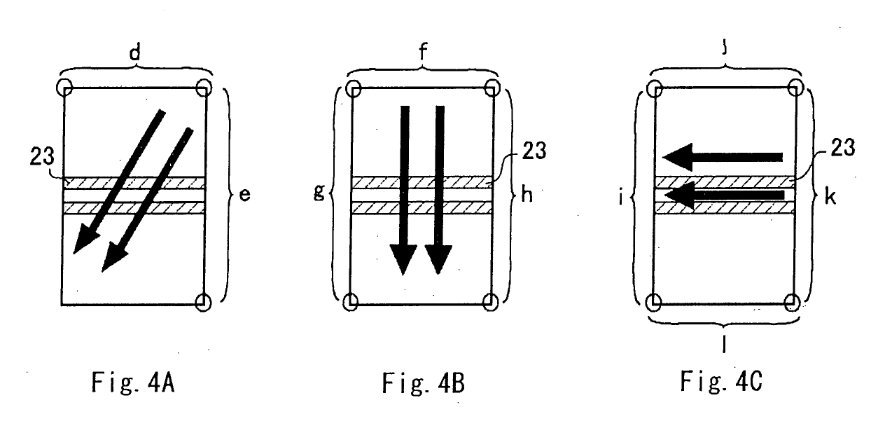

Therefore, as illustrated in FIG. 4A, when the orienting direction of the alignment layer on the substrate on which the protruding portion is formed is inclined with respect to the liquid crystal display device, domain essentially no longer occurs by providing the liquid crystal injection inlet at any of periphery “d” or “e” on the opposite side to the orienting direction of the alignment layer, or the three corners which intersect in that vicinity. Similarly, as illustrated in FIG. 4B, when the orienting direction of the alignment layer is in a longitudinal direction of the liquid crystal display device, domain essentially no longer occurs by providing the liquid crystal injection inlet at periphery “f”, or the periphery “g” or “h” of both sides thereof, of the opposite side to the orienting direction of the alignment layer, or at any of the corners. Similarly, as illustrated in FIG. 4C, when the orienting direction of the alignment layer is parallel to the protruding portion 23 and in a transverse direction to the liquid crystal display device, the orienting direction of the alignment layer is parallel to the protruding portion 23, i.e. the orienting direction of the alignment layer and the protruding portion 23 do not intersect, uniform rubbing of the alignment layer can be realized, whereby domain essentially no longer occurs even if the liquid crystal injection inlet is provided at any of periphery “i”, “j”, “k” or “l”, or even at any of the corners.

What is claimed is:

1. A semi-transmissive liquid crystal display device which employs ECB mode liquid crystals comprising a pair of substrates and providing a protruding portion extending in a first direction used for adjusting a cell gap on a reflective portion of each pixel in one of the substrates, and when an orienting direction of an alignment layer formed on said one of the substrates intersects with said protruding portion extending in said first direction, a liquid crystal injection inlet is provided at a position such that a tangent of a circular arc drawn with said liquid crystal injection inlet as a center and said orienting direction of the alignment layer on the side comprising said protruding portion are never at a right angle, or is provided at a position such that a contact point of the tangent where said tangent of a circular arc and the orienting direction of the alignment layer of said one of the substrates are at a right angle is on an edge of said substrate.

2. The semi-transmissive liquid crystal display device which employs ECB mode liquid crystals according to claim 1 comprising a topcoat wherein said protruding part is provided on a reflective portion of a color filter substrate.

3. The semi-transmissive liquid crystal display device which employs ECB mode liquid crystals according to claim 1 comprising an interlayer film wherein said protruding part is provided on a reflective portion of a matrix substrate side.

4. The semi-transmissive liquid crystal display device which employs ECB mode liquid crystals according to claim 1, wherein when the orienting direction of the alignment layer of said one of the substrates is inclined with respect to said semi-transmissive liquid crystal display device, said liquid crystal injection inlet is provided at any one of a periphery of an opposite side to the orienting direction of said alignment layer, or three corners intersecting in the periphery vicinity.

5. The semi-transmissive liquid crystal display device which employs ECB mode liquid crystals according to claim 1, wherein when the orienting direction of the alignment layer of said one of the substrates is in a longitudinal direction of said semi-transmissive liquid crystal display device, said liquid crystal injection inlet is provided at any one of a periphery, or periphery both sides thereof, of an opposite side to the orienting direction of said alignment layer, or at any of the corners.

6. A semi-transmissive liquid crystal display device which employs ECB mode liquid crystals comprising a pair of substrates and providing a protruding portion extending in a first direction used for adjusting a cell gap on a reflective portion of each pixel in one of the substrates, a liquid crystal injection inlet being provided so that an orienting direction of an alignment layer formed on said one of the substrates is parallel to the protruding portion extending in said first direction.
